(19) United States
(12) Patent Application Publication
(10) Pub. No.: US 2026/0307424 A1
(43) Pub. Date: Oct. 8, 2026

(54) SECURITY ELEMENT FOR A VALUE DOCUMENT, HAVING AN OPTICALLY VARIABLE PRIMARY SURFACE PATTERN AND CONCEALED SECONDARY SURFACE PATTERN, AND METHOD FOR PRODUCTION THEREOF

(71) Applicant: GIESECKE+DEVRIENT CURRENCY TECHNOLOGY GMBH, Munchen (DE)

(72) Inventors: Christoph MENGEL, Holzkirchen (DE); Matthias PFEIFFER, Munchen (DE); Manfred HEIM, Bad Tolz (DE); Andreas RAUCH, Ohlstadt (DE); Bjorn TEUFEL, Weissach (DE); Winfried HOFFMULLER, Bad Tolz (DE)

(21) Appl. No.: 19/100,752

(22) PCT Filed: Aug. 2, 2023
(86) PCT No.: PCT/DE2023/100568

§ 371 Date: Feb. 3, 2025

(30) Foreign Application Priority Data
Aug. 4, 2022 (DE) 10 2022 002 839.5

(51) Int. Cl. B42D 25/387; B42D 25/324; B42D 25/373; B42D 25/45

(52) U.S. Cl. CPC B42D 25/387; B42D 25/324; B42D 25/373; B42D 25/45

(57) ABSTRACT

A security element for a value document, wherein the security element includes: an optically variable primary surface pattern that has a metal layer with a relief structure; and at least one concealed secondary surface pattern having a plurality of elements that perforate the metal layer and at least one luminescence layer that is arranged at least in the region of the secondary surface pattern.

The invention relates to a security element for a value document, having an optically variable primary surface pattern and concealed secondary surface pattern, and to a method for production thereof.

Optically variable surface patterns are known in the prior art and are used as security features and/or security elements that implement movement effects, for example by means of microreflectors. The prior art discloses, in particular, security elements where colors are generated with the aid of nanostructures having structure sizes in the sub-wavelength range.

A combination of micromirrors with nanostructures thereon can create colored rolling effects and/or 3D effects (the “rolling bar” effect using microreflectors is disclosed in DE 10 2010 047 250A1 , and a 3D effect is disclosed in DE 10 2009 056 934A1 ). The micromirrors generate essentially the rolling effect and/or the 3D effect, and the nanostructures color these or else can generate multicolored effects in some cases. The observer is given the impression, for example, of a moving colored motif. Documents WO 2015/078572 A1 and WO 2016/180522 A1 also disclose such illustrative movement effects. The microreflectors or microlenses are arranged here relative to a main plane such that the motif has or maps the movement effect on tilting and/or rotation of the security element.

Typically, as described in document WO 2021/028076 A1 for example, such nanostructures are molded into a transparent embossment varnish and coated with a metallic or highly refractive layer.

In order to improve forgery security, security features and/or security elements sometimes have what are called class 2 features that can be read out with auxiliary equipment, for example a UV lamp.

It is an object of the present invention to provide a security element having alternative properties and effects.

It is a further object of the present invention to provide a security element having alternative class 2 features.

It is a further object of the present invention to provide a security element having high forgery security.

It is another object to make nondestructive detachment of the security element from an article and/or a substrate difficult or even impossible.

It is a further object for the effect of the security element that can be seen with the aid of auxiliary equipment to appear in a particularly distinctive and/or esthetically pleasing manner to the observer.

It is a further object of the present invention to provide a security element that is not perceived as an objectionable element and allows an article to be safeguarded therewith to have a more esthetically pleasing appearance.

It is another object to provide a corresponding method of producing a security element.

At least one of these objects is achieved by the respective subject matter of the independent claims.

In one aspect, a security element for a document of value includes or comprises an optically variable primary surface pattern comprising a metal layer having a relief structure, especially a microstructure, a nanostructure and/or a sub-wavelength structure; and at least one concealed secondary surface pattern comprising a multitude of elements that perforate the metal layer, and at least one—preferably at least partly transparent—luminescent layer disposed at least partly in the region of the multitude of elements that perforate the metal layer. The elements that perforate the metal are also called perforating elements.

The security element has additional and/or alternative properties and effects with respect to the security elements already known. The security element especially has additional and/or alternative class 2 features with respect to the security elements already known. The security element has high forgery security with respect to the security elements already known. With the aid of auxiliary equipment, discernible effect of the security element appear particularly distinctive and/or esthetically pleasing to the observer. Moreover, the security element is not perceived as a disruptive element on a document of value, a product and/or a substrate, and causes an article to be safeguarded therewith to have a more esthetically pleasing appearance.

The metal layer is an opaque layer which is opaque, i.e. nontransparent, to light and especially to emitted light that excites luminescence (also “excitation of luminescence”). The optically variable primary surface pattern may form a motif with optically variable properties. The motif may comprise an image of a real object, symbols, ornaments, fantasy elements and/or other motifs. The optically variable primary surface pattern may be visible to an observer under incident light. This purpose can be served, for example, by daylight incident from the observer's side of the security element. The optically variable primary surface pattern may be or become visible to the observer especially in the case of incidence of visible light. The light incident from the side of the security element facing the observer can then be scattered, reflected and/or diffracted at the perforated metal layer with a primary surface pattern such that an optically variable, viewing-angle-dependent motif appears.

The relief structure, especially the microstructure, the nanostructure and/or the sub-wavelength structure, may comprise an optically variable micro-and/or nanorelief, preferably with dimensions or measurements within and/or below the visible wavelength range, especially holograms, micromirrors, microlenses and/or corresponding or other nanostructures.

The concealed secondary surface pattern, particularly in the case of incidence of daylight and/or from a white light source, can be seen by an observer only with difficulty, and preferably not at all. The concealed secondary surface pattern corresponds to at least one of the luminescent layers together with the perforation of the metal layer, especially in the perforation region and/or according to a predetermined pattern. The perforation may be created by stamping, etching material away or another way of removing or demetallizing the metal layer. The concealed secondary surface pattern may form a further motif and/or a piece of information by means of the perforating elements or perforating structure or perforating pattern. The perforating elements may form a substructure of the motif. The perforating elements may correspond to a pattern. For example, the elements may have the shape of crosses (as substructure elements) and, in their entirety, together map a cross as the higher structure. The elements that perforate the primary surface pattern correspond essentially to demetallized regions of the metal layer, i.e. regions that are not covered and/or coated with the metal layer. Therefore, the metal layer of the primary surface pattern is holey or patchy. The perforating elements may be in a regular or chaotic arrangement in the area. The multitude of elements that perforate into the metal layer or the multitude of elements that perforate the metal layer (“perforating elements” for short), as already mentioned, form the substructure, where the perforating elements together form a higher (meaningful) motif. The concealed secondary surface pattern may moreover be machine-readable, i.e. create invisible emission (e.g. UV light) on excitation of luminescence, which is detectable by a measurement device and/or a detector.

The luminescent layer may be disposed above and/or beneath at least a portion of the primary surface pattern and/or within the perforating elements or perforations or gaps. The luminescent layer may correspond to a luminophore layer. The regions of the security elements, especially of the film security element with the demetallized pattern, may be highlighted with one or more fluorescent colors as one or more luminescent layers. The luminescent layer may be excited in the invisible UV range and may emit light in the visible wavelength range, such that the concealed secondary surface pattern is discernible to the human eye. Additionally or alternatively, the emitted light, as already mentioned, may also lie in the nonvisible wavelength range and therefore be (solely) machine-readable. The concealed secondary surface pattern may thus also comprise a machine-readable security feature that emits a light which is detectable, for example, in the nonvisible wavelength range, especially in the UV range. The primary surface pattern may comprise an optical security feature which is apparent in the visible wavelength range.

The combination of the perforating elements (that correspond to the demetallized regions in the metal layer) and the luminescent layer above, beneath and/or in between has the effect that the concealed secondary surface pattern and possibly a higher motif formed therefrom becomes visible to the observer on excitation by radiation, especially by UV radiation. The UV radiation may be incident on the security element from the observer's side and/or from the reverse side.

Moreover, the perforation has the effect that the concealed secondary surface pattern and possibly a higher motif formed therefrom becomes visible to the observer under transmission light. A light visible to the observer passes here from the reverse side of the security element through the perforating elements. This visible light may, for example, be daylight and/or the light from a white light source.

In other words, in each case under transmission light and under the action of excitation of luminescence, such as UV light, a concealed secondary surface pattern and a concealed higher motif may become visible on a metallized film security element which is formed from the multitude of small demetallized regions of the concealed secondary surface pattern.

The security element, especially a strip, called a LEAD, and/or a patch can therefore be provided with the class 2 feature for further safeguarding. A class 2 feature typically means a security feature that can be authenticated with auxiliary equipment, for example a UV lamp. The concealed secondary surface pattern therefore serves as a class 2 feature or class 2 security feature. A LEAD corresponds to a strip and may extend over the length and/or width of a document of value, for example a banknote. A patch, by contrast, is locally limited, i.e. may be smaller in terms of its dimensions (length and/or width) than the document of value itself. An L patch or L-LEAD corresponds to an applied or introduced patch or strip having its own carrier or its own substrate. Such an L patch or L strip is correspondingly applied to/introduced into a document of value with the carrier. A T patch or T strip corresponds to an applied and/or introduced patch or strip which is parted from a transfer carrier and applied to/introduced into a target substrate and/or document of value. A T patch or strip may either not have its own carrier or optionally have its own carrier.

The security element may have a sandwich structure, which—without stipulating the sequence of layers—has the metal layer perforated by the elements of the concealed secondary surface pattern with a relief structure of the optically variable primary surface pattern and the at least one luminescent layer. In other words, the security element may have a sandwich structure having a holey metal layer and at least one luminescent layer in the region of the holes of the metal layer. The sandwich structure may be formed and/or disposed on a carrier, where the carrier can be removed from the sandwich structure. As well as the two mentioned layers of the sandwich structure, there may also be other functional layers that are described somewhat later in the description as possible embodiments. The at least one luminescent layer may be disposed directly above and/or beneath the perforated metal layer and may cover the multitude of elements that perforate the metal layer such that the luminescent layer can be irradiated through the perforating elements, i.e. through the holes, and can emit luminescent radiation (also “emission radiation”) through the latter, in such a way that a motif becomes apparent to the observer under transmission light and/or on excitation of luminescence and arises from and/or is composed of the elements of the concealed secondary surface pattern that perforate the metal layer, but is not apparent under incident visible light.

The luminescent layer may comprise a luminophore layer, a fluorescent layer and/or a phosphorescent layer, wherein the fluorescent layer may be set up to fluoresce and the phosphorescent layer may be set up to phosphoresce.

Luminescence may be regarded as a collective term for luminous effects having essentially no thermal radiation. If the light emits luminescent radiation immediately after excitation by the luminophore, i.e. within a period of time of a few microseconds after excitation of the luminophore medium, this is typically fluorescence. However, if the light is emitted with a longer delay after excitation, with the delay typically in the region of seconds or higher, this is phosphorescence. What is specifically described herein is excitation by UV light. However, this invention is not limited to this type of excitation. In general, the luminescent layer of this invention may comprise the following types of luminescence: photoluminescence, x-ray luminescence, sonoluminescence, radioluminescence, chemoluminescence, bioluminescence, luminescence of technical luminophores, as in luminophore lamps for example.

Photoluminescence is the most common and also preferred luminescence that is considered in this invention. A UV lamp for excitation of the luminescent layer is easy and uncomplicated to operate, and the security element can be verified rapidly and easily. Photoluminescence typically occurs under or after illumination or excitation with UV light, where the wavelength of the radiation emitted is typically greater than that of the exciting radiation since energy is lost as a result of the excitation.

The optically variable primary surface pattern may comprise an embossment layer, especially an embossing varnish layer, above and/or beneath which the metal layer is disposed.

An embossment layer may comprise a polymer, for example a resin and/or varnish, into which a relief is incorporated. The relief is predetermined, and its structure corresponds to the optically variable primary surface pattern. It may have a relief structure, such as a sub-wavelength structure, a nanostructure and/or a microstructure, which, in particular after coating with a metal layer, generates an optically variable and viewing-angle-dependent effect, for example an optically variable color impression and/or another optically variable effect, for example a rolling effect, a 3D effect and/or a floating effect, a hologram, a movement effect or the like.

The metal layer may correspond to a thin metal foil and/or correspond to a vapor-deposited, sputter-applied and/or electrochemically applied metal layer. The metal layer may therefore serve as a mirror. The metal used may be a suitable reflector metal, for example aluminum.

The metal layer may be disposed directly or indirectly with the interlayer on, below and/or above the embossment layer. Positioning of a layer above or beneath another layer may generally be regarded as indirect or direct positioning or layer arrangement.

The perforating elements (that perforate the metal layer) may also perforate the embossment layer and/or other layers, although this is not absolutely necessary, rather merely optional.

The security element may further comprise an opaque region surrounding the primary surface pattern.

The opaque region is a region essentially opaque to visible light. The first concealed motif region and/or the second concealed motif region, and in particular the metal layer with the primary surface pattern and the secondary surface pattern concealed two-dimensionally therein, may therefore be embedded into the opaque (edge) region, which may for example have a particularly esthetically appealing appearance.

The opaque region may have a uniform color or multiple colors that have a particularly esthetically pleasing appearance. The opaque region may also comprise a coating that comprises and/or covers other elements, for example an adhesive layer and/or an electronic element. The opaque region may comprise an opaque layer or be formed by an opaque layer, where the opaque layer may serve as a substrate and/or support layer, especially for the holey metal layer. Otherwise, the opaque region may be formed from an opaque layer. The opaque region may in any case have been formed or be formed from an opaque layer that supports and/or stabilizes the first concealed motif region and/or the second concealed motif region, and in particular the metal layer, laterally and/or from the underside. It is thus possible to prevent, for example, inadvertent tearing of the metal layer at its sides.

The security element may further comprise a transparent region surrounding the primary surface pattern.

An at least partly transparent region that at least partly surrounds the primary surface pattern, i.e. the perforated metal layer, can give the observer the impression that only the central element, specifically the security element of the invention without additional visible edge regions, is disposed on the document of value. Visible regions that surround the central element and are possibly perceived as being objectionable are thus dispensed with here, with simultaneous provision of sufficient contact area to fix the security element on the document of value and/or substrate. Therefore, the security elements may be perceived as being particularly esthetically pleasing and not as an objectionable element on a document of value.

Especially in the case of patches, a central region with optically variable features (such as a color shift) including the opaque metal layers may be embedded into a transparent and/or opaque edge region.

The perforating elements may have at least one of the following shapes: geometric shapes, especially triangular, rectangular, rhombus-like or circular shapes, preferably annular or solid circular shapes, alphanumeric symbols, symbols, ornaments, lines and meshes. Circular elements may also be regarded as point elements, especially in the case of a very small radius.

In general, the perforating elements may have individual forms and, in their entirety and arrangement, in turn form a higher shape or structure. In other words, the multitude of perforating elements (that perforate the metal layer) may have a substructure, where the elements together may form a higher motif. For example—as already mentioned—small cross-shaped elements may form a higher cross. The shapes of the elements may preferably be perceptible as such to the observer and have appropriate dimensions. It is possible, for example, for the shapes to be uniform, for example circular shapes only. There may alternatively be different shapes, such as round and rectangular shapes.

The perforating elements may have a size—such as length and/or width—of 10-500 μm and preferably of 50 -250 μm. The length (or a maximum size in any direction) and width (or a minimum size in any direction) of the perforating elements are preferably within the (preferred) range. Alternatively, only the width is within the (preferred) range. The circular shapes may each have a diameter, for example, of 10-500 μm and preferably of 50 -250 μm. The dimensions of the perforating elements may be uniform or nonuniform. With these dimensions of the perforating elements, the shapes thereof may still be visible or apparent under transmission light and/or on excitation of luminescence. The light reflected and/or scattered under incident light by the metal layer of the primary surface pattern does not outshine the light from the luminescent layers emitted by excitation of luminescence and/or the transmitted light that passes through the perforating elements in each case to any great extent, and so the shapes of the perforating elements are apparent to the observer due to light passing through them.

The perforating elements may have a lateral distance from one another of 10-500 μm, preferably 50 -250 μm. The distance between the perforating elements is preferably greater than their size. The lateral distance or side distance between two perforating elements may especially be a distance between two mutually facing contour edges of two perforating elements. The lateral distances are chosen here such that they correspond to the shortest distance between two mutually facing contour edges of two perforating elements. The lateral distances may alternatively also be the distances between the center points and/or geometric centroids or centers. The distances are preferably chosen such that they can be perceived as individual perforating elements, the shape of which is essentially still apparent.

In the region of the perforating elements, the area proportion of the perforating elements (perforation area to perforated area) may preferably be 10% to 60%, preferably 20% to 49%, more preferably 20% to 42%.

The luminescent layer may be excitable in the UV range at discrete wavelengths or in a continuous spectral range. The luminescent layer(s) is (are) preferably excitable solely with light from the range from 315 nm to 405 nm, further preferably 350 to 400 nm. For example, excitation can be effected at 254 nm, 395 nm and/or 365 nm. The luminescent layer may include a luminescent material that can be excited in said wavelength ranges and, as a result, emits a light that typically has a different, generally longer, wavelength. It is also possible to use different luminescent materials of different excitation and/or emission wavelengths/frequencies. Moreover, there may be two or more luminescent layers of different excitation and/or emission wavelengths in the security element, and these may be arranged, for example, alongside one another, one on top of another and/or in a plane. Luminescent layers of different excitation and/or emission wavelengths are also referred to herein as luminescent layers of different type. The security element may then be read under the influence of multiple excitation wavelengths, which leads to further anti-forgery security. Moreover, broadband UV excitation can result in visualization of a concealed secondary surface pattern having multiple emission colors, which has a particularly esthetically appealing appearance. It is also possible for there to be one emission wavelength in the visible and another in the invisible region, such that the visible emission can be detected by the observer and the invisible emission by a device (in a machine-readable manner), which leads to additional security with regard to verification.

At least in the region of the concealed secondary surface pattern, especially in the region of the multitude of perforating elements, there may be disposed at least one semitransparent layer having a transparency of at least 25%. At least one transparent layer may be arranged essentially over the full area above and/or beneath the primary surface pattern. The semitransparent layer may have a filter effect, such that particular wavelengths cannot pass through the layer. The semitransparent layer may additionally or alternatively also correspond to a protective layer.

At least some of the multitude of elements perforating the metal layer may at least partly be filled with an adhesive material, as a result of which the adhesive material can form island layers, and where the adhesive material may preferably comprise a UV-curing polymer.

The security element may then be mounted on a document of value, in such a way that the adhesive material makes contact with a surface of the document of value and/or a substrate. If the adhesive material comprises a UV-curing polymer, the polymer may be cured by irradiation with a suitable wavelength after being positioned on the document of value. If the tie layer is irradiated through the multitude of perforating elements, the result is a corresponding multitude of cured adhesion islands in the tie layer. The formation of adhesion islands is particularly suitable for countering forgeries of documents of value, since nondestructive removal of the security element is impossible. Multipoint, relatively stable fixing of the security element on a document of value can reliably have the effect that the latter tears when detachment is attempted. It is thus impossible to transfer the security element in a nondestructive manner from a document of value to another object.

The adhesive material or tie layer is preferably at least partly transparent, in such a way that it allows light for excitation of the luminescent layer and light emitted as a result from the luminescent layer to pass through, or transmits it, and does not disrupt or even hinder the function and effects of the security element of the invention.

In one aspect, a method of producing a security element comprises: positioning a metal layer above a substrate and/or a carrier, especially a carrier film, and forming a relief structure in order to create an optically variable primary surface pattern; perforating or demetallizing the metal layer in the form of a multitude of perforating elements in order to create a concealed secondary surface pattern; and positioning an at least partly transparent luminescent layer in the region of the multitude of perforating elements of the concealed secondary surface pattern. The process for producing the security element has all the advantages and effects of the security element in the corresponding embodiment.

The substrate may optionally be removable and/or detachable, such that the security element can be removed from the substrate after production thereof and applied to a document of value. In this case, there may be an adhesive layer between the substrate and an (uppermost/lowermost) layer of the security element, or one may be applied after the substrate has been removed. The substrate may also already be part of the document of value.

The forming of the relief structure may comprise: positioning an embossment layer, especially an embossing varnish layer, above the substrate and especially on the substrate or onto another layer on the substrate; embossing the relief structure into the embossment layer; and applying the metal layer to the embossment layer. An embossment layer, especially an embossing varnish layer, for example a polymer, especially a resin, is of particularly good suitability for introduction of a relief structure (microstructure and/or nanostructure and/or sub-wavelength structure), above which the metal layer is then disposed, in order to form the primary surface pattern.

The perforating and/or demetallizing of the metal layer may comprise at least one of the following methods: a washing method, an etching method, a laser ablation, a metal pigment print with cutouts, a metal transfer method, a stamping operation, a mechanical and/or electrochemical removal operation, a pulling-away operation.

The metal layer may alternatively also be applied or positioned (for example by means of vapor deposition) so as to form, rather than a coating over the full area, a metal coating (also “metallization”) with predetermined gaps corresponding to the perforating elements of the concealed secondary surface pattern. A mask corresponding to the form of the multitude of perforating elements may be applied prior to vapor deposition of the metal layer, which is removed at a later stage (pulled away, taken down and/or etched away). In this way, a multitude of elements perforating the metal layer may be formed as a “shadow” in the metallization or coating with a metal.

The first luminescent layer and/or the second luminescent layer are preferably printed on. One or both luminescent layers may be vapor-deposited.

The first and second luminescent layers may be disposed in a transparency region and/or perforation region. The method may further comprise positioning a metal layer comprising a relief structure that corresponds to an optically variable surface pattern and/or is opaque in regions and/or has been provided with perforating elements, such that one or more opaque regions and/or one or more perforation regions are formed.

In one aspect, a security element for a document of value comprises: an optically variable primary surface pattern visible under incident light; and an element pattern that perforates the primary surface pattern and is visible under transmission light and is/becomes visible under excitation of luminescence (especially under excitation of fluorescence).

The perforating element pattern corresponds essentially to the multitude of perforating elements of the secondary surface pattern described herein and has the property, under excitation of luminescence, of emitting light, especially a visible light, and, under transmission light, of transmitting a portion of the light that onto the reverse side of the security element.

This security element may have the aforementioned features according to another aspect and of other embodiments described herein, without explicitly being mentioned herein as a combination. The optically variable primary surface pattern may form or be a motif with optically variable properties. The element pattern may have a substructure of perforating elements that interrupt or introduce holes into the primary surface pattern, especially a metal layer of the primary surface pattern. It is possible to fill or apply an at least partly transparent and luminescent, especially fluorescent, material into, above and/or beneath the perforating elements of the element pattern. The element pattern is visible only under transmission light and under excitation of luminescence, especially under excitation of fluorescence.

The term “transmission light” should be understood herein such that incident light is a light such as daylight from the side of the security element remote from the observer (reverse side, “from the back”) incident through the perforations of the secondary surface pattern and/or the element pattern. The element pattern may comprise a further motif and/or a piece of information which is formed by means of the perforating structure (substructure of perforating elements). The secondary surface pattern or element pattern may therefore become visible to the observer in the case of incidence of transmission light and in the case of incidence of a light at least of a particular excitation wavelength which is able to excite a luminescent material used.

The optically variable primary surface pattern may be formed by at least one motif layer having a relief structure, such as a microstructure, a nanostructure and/or a sub-wavelength structure. The at least one motif layer may comprise: a metal layer; and preferably an embossment layer, above and/or beneath which the metal layer is disposed.

Above and/or beneath the primary surface pattern, at least in the region of the element pattern, may be disposed at least one partly transparent luminescent layer, especially at least one fluorescent layer.

In general, a security element may be an element applied to and/or introduced into a substrate as a “strip” (for example from end to end in a banknote) or as a “LEAD” or as a “patch” (in a locally limited manner). A security element may be an element introduced and/or applied as a “filament” arranged on and/or in a substrate and/or carrier. A security element may also be created directly on the target substrate, i.e., for example, a document of value.

In general, security elements may be present with or without a dedicated substrate or dedicated carrier. The substrate or carrier may have a plastic carrier and/or a film, such as a PET film. The substrate or carrier may be transferred to a document of value or be present beforehand on a transport/production carrier. The substrate and/or carrier of the document of value may comprise one or more paper layers or one or more polymer layers or a combination of paper and polymer layers.

In general, a security feature of a security element may, for example, be a feature printed onto a substrate or present within a substrate. A security feature may comprise features that serve to safeguard a banknote, such as printed IR/UV dyes and/or luminescent layers and/or fibers.

What is meant essentially by the expression “optically variable” is that different impressions become visible or apparent to the observer depending on a viewing angle, a viewing direction (including tilting/rotating), a side of the security feature (front side/reverse side), a reflection (front view) and/or a transmission (through view, i.e. toward the light source), where an optically variable security feature may have a color effect, a moving motif, a floating motif and/or a rolling effect.

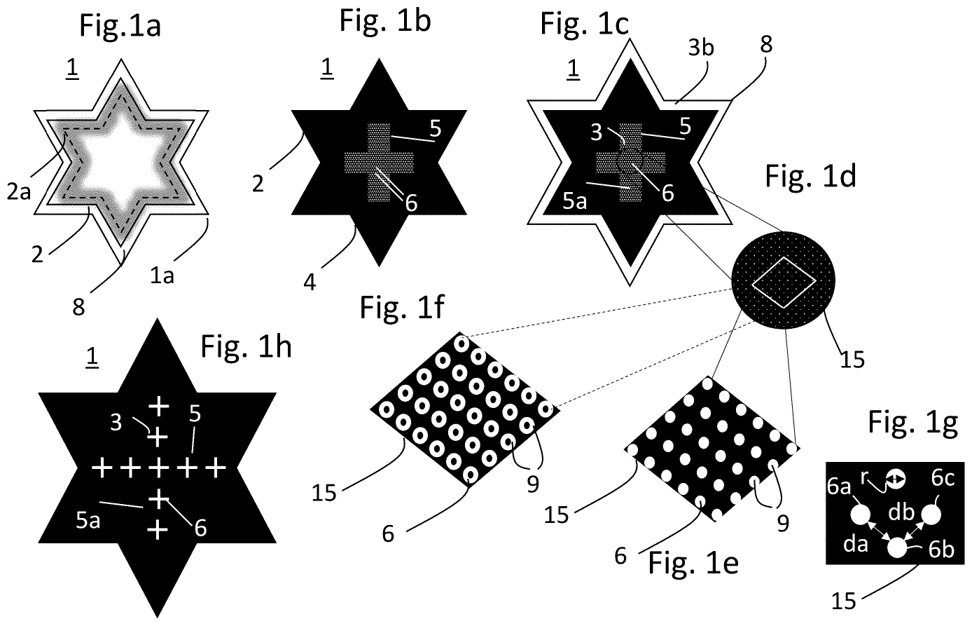

FIG. 1a is a schematic diagram of a security element under incident light in one embodiment;

FIG. 1b is a schematic diagram of the security element of FIG. 1a under transmission light;

FIG. 1c is a schematic diagram of the security element of fig. la on excitation of luminescence;

FIG. 1d is a detail from the schematic diagram of the security element of FIG. 1c and shows a schematic of some of the multitude of perforating elements of the secondary surface pattern;

FIG. 1e is a detail from the diagram of FIG. 1d in one possible embodiment;

FIG. 1f is a detail from the diagram of FIG. 1d in an alternative embodiment to FIG. 1e;

FIG. 1g is a schematic diagram of perforating elements shown in FIG. 1e;

FIG. 1h is a schematic diagram of a security element under transmission light and/or on excitation of luminescence in a further embodiment;

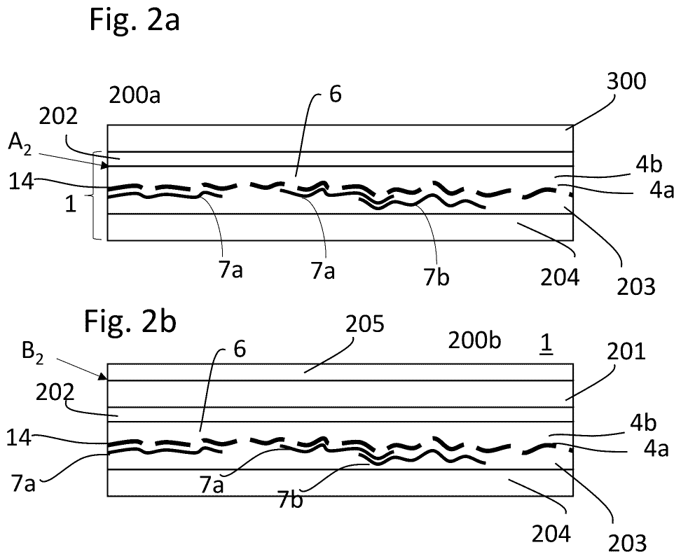

FIG. 2a is a schematic diagram of a layer arrangement of a security element as a T strip in one embodiment;

FIG. 2b is a schematic diagram of a layer arrangement of a security element as an L strip in one embodiment;

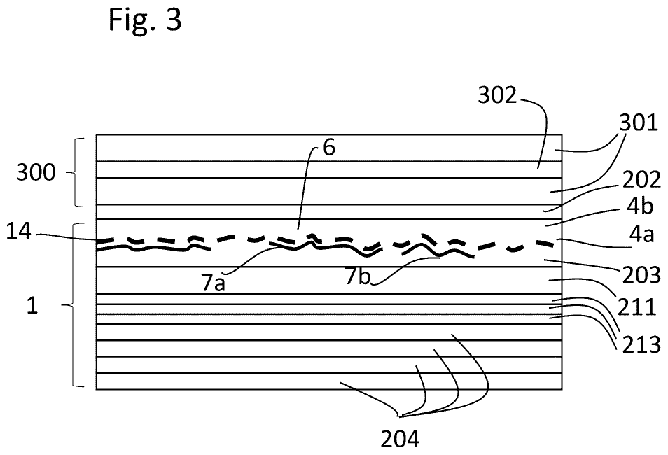

FIG. 3 is a schematic diagram of a layer arrangement of a security element as a patch in one embodiment;

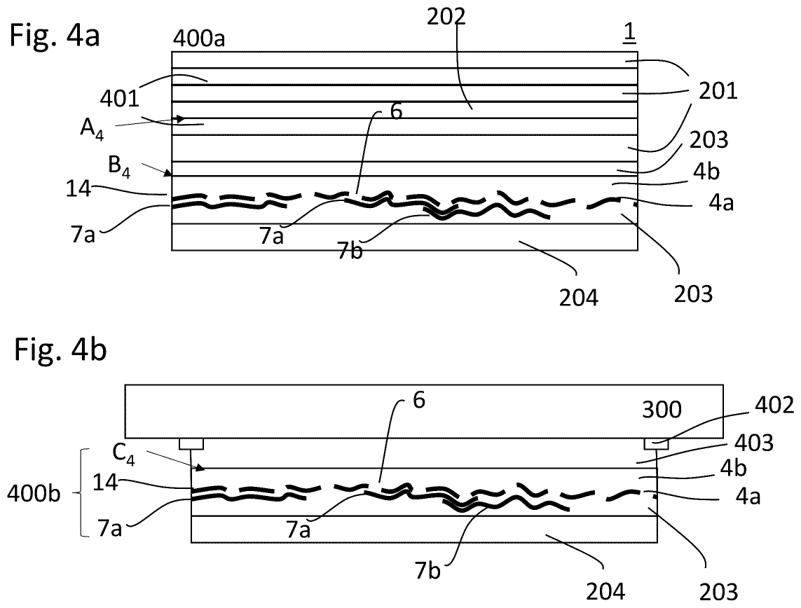

FIG. 4a is a schematic diagram of a layer arrangement of a security element as an L patch in one embodiment;

FIG. 4b is a schematic diagram of a layer arrangement of a security element as a T patch in one embodiment; and

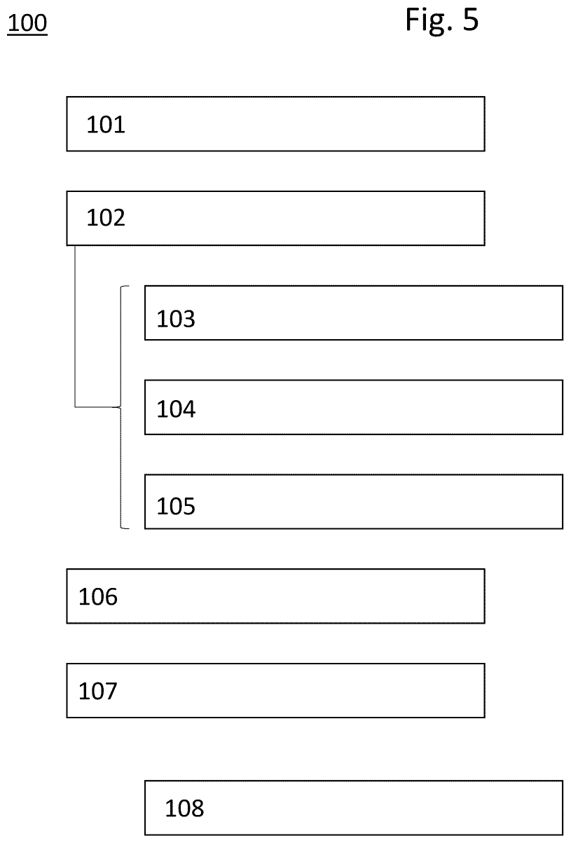

FIG. 5 is a schematic diagram of a method of producing a security element in one embodiment.

Unless stated otherwise, the same reference numerals are used for identical and equivalent elements and/or features. Redundant description of recurring features and any redundant use of recurring reference numerals is dispensed with to some degree. The different embodiments and features of the figures described hereinafter are explicitly combinable and should not be regarded as self-contained executions.

FIG. 1a is a schematic diagram of a security element 1 under incident light in one embodiment. FIG. 1b is a schematic diagram of the security element 1 from FIG. 1a under transmitted light and FIG. 1c is is a schematic diagram of the security element 1 from FIG. 1a on excitation of luminescence (also “excitation”).

The security element 1 in this embodiment has the outline 1a of a star and can be used for authenticity verification and safeguarding of a document of value and/or an article of value. The security element 1 comprises an optically variable primary surface pattern 2 which is shown in FIG. 1a and forms the shape of a star 2a that has a three-dimensional appearance to the observer. Under incident light, i.e. when visible light, for example white light, is incident from the observer's side onto the security element 1, the star 2a that stands out in three-dimensional form from the surface appears as a motif of the primary surface pattern 2, as shown in FIG. 1a. The star 2a which is generated by the optically variable primary surface pattern 2 and appears to stand out from the surface is indicated by the dotted line. The primary surface pattern 2 creates this motif 2a that appears in three-dimensional form since it has a relief structure 4a with a metal layer 4 above it that is capable of creating this motif. The relief structure 4a corresponds here to a micro-and/or nanostructure comprising a multitude of mirror elements (such as micromirrors) and/or lens elements (such as microlenses) that can create a viewing-angle-dependent interference and hence such a 3D effect.

The metal layer does not fill the entire star shape of the security element 1, but rather forms a smaller star within the outline 1a of a star of the security element 1. The metal layer is surrounded by a transparent region 8, which forms the region between the outline 1a and the smaller star-shaped contour of the metal layer. The transparent region 8 may form an essentially transparent area. The transparent (edge) region 8 fully surrounds the primary surface pattern 2 (as the inner region). Especially in configurations as strips (and optionally also for a patch), the primary surface pattern 2 is surrounded by exactly two lateral transparent edge regions. It is thus possible to prevent, for example, inadvertent tearing and/or fraying of the metal layer at its sides.

In the transparent region 8, the security element may comprise, for example, the carrier layer and/or an embossing varnish layer and/or a transparent protective layer and/or a tie layer. The layers mentioned may equally be present in the (region of the) primary surface pattern 2, where the metal layer is preferably present atop the embossing varnish layer and/or beneath the protective layer. The transparent region 8 may likewise include regions of the first and/or second luminescent layer as transparent luminescent layer. It is possible to prevent, for example, inadvertent tearing and/or fraying of the metal layer at its sides.

In the region of the primary surface pattern 2, the metal layer may be in perforated form in some regions. The primary surface pattern 2 in this respect comprises an opaque region 4 and one (or more) perforation region(s) 5. In incident light, these regions of the primary surface pattern are not apparent and therefore not shown in FIG. 1a. The observer sees the motif of the primary surface pattern 2 in the opaque region 4 (and preferably in the perforation region 5). The transparent region 8 is preferably barely apparent to the user in incident light, i.e. is not apparent outside a gloss angle in particular.

The embodiment shown is shown merely by way of illustration in the form of a star, and any other form is conceivable. The indicated three-dimensional effect of the optically variable primary surface pattern 2 is also shown merely by way of example, and the security element may instead or additionally have other effects, such as color effects, rolling effects, floating effects or movement effects.

In incident light alone, as shown in FIG. 1a, the concealed secondary surface pattern 3 is not apparent or perceptible. Only in a situation (in incident light) as shown in FIG. 1b will a perforation region 5 be visible. Only in a situation (excitation of luminescence) as shown in FIG. 1c will the concealed secondary surface pattern 3 be visible or apparent to the observer.

FIG. 1b shows the security element 1 when viewed in transmission light. The metal layer comprises an opaque region 4 and a perforation region 5 in which there is a multitude of perforating elements 6. The elements 6 that perforate the metal layer are thus lit “from the back”, i.e. from the side of the security element 1 remote from the observer. The perforating circular elements 6 with regular separation from one another and uniform radius form a substructure 15. It will be apparent to the observer that the multitude of perforating elements 6 collectively have the higher shape 5a of a cross. The higher shape 5a of the perforation region 5 with perforating elements 6 may also be referred to as a transmission light motif of the security element.

In the region of the primary surface pattern 2, there are one (or more) perforated regions 5 and at least one unperforated or opaque region 4. The perforated region 5 is preferably surrounded by an unperforated or opaque region 4. In the present case, the primary surface pattern 2 is in turn surrounded by the transparent region 8. The transparent region 8 is not apparent in transmission light (and preferably not in incident light either). The substructure 15 is preferably not apparent in transmission light to the observer's naked eye (without auxiliary equipment).

The concealed secondary surface pattern 3 not only has the multitude of elements 6 that perforate the metal layer 4, but also at least one (preferably at least partly transparent) luminescent layer disposed in the region of the perforating elements 6. The luminescent layers may be at least partly transparent, in order to be able to transmit a light from the reverse side. The at least one luminescent layer may be disposed above, beneath and/or within at least some of the perforating elements 6. It may especially be in the perforation region 5 and the edge region 8.

In FIG. 1c, a UV light comprising the corresponding excitation wavelength for excitation of the luminescent material of the luminescent layer is shone onto the region of the secondary surface pattern 3. This may be incident in transmission light (“from the back”, the side of the security element 1 remote from the observer) and/or in incident light (“from the front”, the side of the security element 1 facing the observer). Since excitation and/or emission wavelengths of luminescent layers may differ, the concealed secondary surface pattern 3 having different excitation wavelengths may be excitable in regions or may comprise two concealed motif regions and/or may have a multicolored appearance, especially when the luminescent layers are disposed at least partly alongside one another beneath the perforating elements 6.

A first luminescent layer may be present, for example, in the perforation region 5, and a second luminescent layer over the full area (or both in the perforation region 5 and in the edge region 8). This is accordingly the appearance-as indicated in FIG. 1c—of the emission of the two luminescent layers, i.e. the concealed motif region 3 in the perforation region 5 and the emission of the second luminescent layer or the motif region 3b thereof in the transparent region 8. In the case of excitation of luminescence with solely a first/second excitation wavelength, it would additionally be possible for only the first/second motif region 3/3b to appear. If the emissions of the two luminescent layers are distinguishable in color by the observer, the security element is particularly easily verifiable.

The substructure preferably remains nondiscernible to the observer's naked eye on excitation of luminescence. The observer will see the luminescence of the luminescent layers in the perforated region 5a (and in the transparent region 8) and will be able to discern the shape of the perforated region and/or possibly the subregions beneath of the luminescent layers.

FIG. 1d is a detail from the schematic diagram of the security element 1 of FIG. 1c (or 1b) and shows a schematic of some of the multitude of perforating elements 6 of the secondary surface pattern 3. It is apparent that the perforating elements 6 form a substructure 5 in which perforating elements 6 are circular, and have a uniform size and mutually uniform separation. FIG. 1e and FIG. 1f are mutually alternative details from the diagram of FIG. 1d in two possible embodiments. According to FIG. 1e, the perforating elements 6 may be circular and cover the full area or be in a dot pattern. Light can thus be transmitted and emitted over the whole area of the circular perforating elements 6. Alternatively, the perforating elements 6 in FIG. 1e may be circular and annular. It is thus possible to transmit and emit light only within the annular region of the perforating elements 6.

FIG. 1e and FIG. 1f are now to be used to briefly describe a further advantageous effect of the perforating elements 6. The security element may comprise a tie layer and/or be secured to a target substrate by means of a tie layer. The tie layer is preferably a (UV) radiation-curable tie layer. If the radiation-curable tie layer is then irradiated through the perforating elements 6 (with appropriate UV light), the tie layer will cure only in places, namely in the region of the perforating elements 6. What is then formed at the time of irradiation or transfer to a target substrate is a tie layer cured only in places (or in insular fashion). FIG. 1e and FIG. 1f indicate, in simplified form, the position of the adhesion islands 9 in the otherwise uncured tie layer, which correspond in size and position to the perforating elements 6 in the metal layer 14 (above). This is an option in order to prevent the security element 1 from being removable nondestructively from the target substrate and transferable to a different substrate and/or object than the original document of value to which it is bonded via the adhesive islands 9. In the event that the security element 1 is pulled away from the document of value, to which it has better bonding in places (by means of the adhesion islands 9), the security element 1 or target substrate will tear. All the perforating elements 6 shown herein may optionally create such cured adhesion islands 9 of glue or another adhesive material without any explicit mention thereof by the corresponding sections of the description that follows or heretofore.

FIG. 1g is a schematic diagram of perforating point elements 6 as shown in FIG. 1e. A first perforating element 6a has a distance da from a second perforating element 6b. The second perforating element 6₂ has a distance db from a third perforating element 6c. The distances d₁ and d₂ between two most closely adjacent perforating elements 6 are identical to one another here. The distances d₁ and d₂ correspond to the shortest distances between the respective outlines of two perforating elements 6. The size, i.e. the radius r, of the perforating elements 6 is also uniform here.

FIG. 1h shows an alternative to the perforating elements 6 so far. FIG. 1h therefore shows a schematic diagram of a security element 1 in the case of excitation of luminescence by means of the UV-A light of the first and second excitation wavelengths (and/or under transmission light) in another embodiment.

Each perforating element 6 has the shape of a circle. The substructure 15 formed by arrangement of the cross-shaped perforating elements 6 gives rise in turn to a cross as the higher shape 5a. The higher shape 5a and the shape of the perforating elements 6 are apparent to the observer. In the example of FIG. 2h, the individual perforating elements 6 could each be highlighted with different luminescent layers 7a, 7b, 7c, for example alternately or in a (multicolor) pattern. Perforating elements 6 may be configured (in terms of size) such that the shape of the perforating elements 6 is apparent to the observer only with auxiliary equipment, such as a magnifying glass or camera (FIG. 1c), or even without auxiliary equipment, to the naked eye (FIG. 1h). Analogously, the substructure 15 may be apparent only with auxiliary equipment, such as a magnifying glass or camera, or be apparent even without auxiliary equipment, to the naked eye.

Alternatively, it would also be possible, for example, for small microscopic symbols, for example an “A”, to give rise to a macroscopic symbol, such as an “A”. It would also be possible, for example, for small microscopic symbols, for example an “A”, to give rise to a microscopic symbol, such as a “B”. In addition, it would also be possible for different symbols, for example “§&A+T&# . . . ” to give rise to or form a macroscopic number, for example “100”.

Various possible layer arrangements of the security element 1 are shown hereinafter for various embodiments. The layer arrangements each always have two varieties or types of luminescent layers 7ₐ, 7_{b}, which have a partial mutual overlap. The two luminescent layers 7ₐ, 7_{b} have different excitation wavelengths and/or emission wavelengths. The configurations already described may exist in all the configurations that follow, especially the regions, including motif regions, perforation region(s), opaque region(s) and/or transparent (edge) region(s), even if they are not addressed again or shown in the figures.

FIG. 2a is a schematic diagram of a layer arrangement 200a of a security element 1 as a transfer strip (T-LEAD) on a transfer carrier 300 in one embodiment. The layer arrangement 200a is on the transfer carrier 300 in the form of a carrier film. Firstly applied to the transfer carrier 300 is a release layer 202 (and/or adhesion layer), which firstly bonds the other layers to the transfer carrier 300, but if required—mainly in the case of transfer of the security element to a target substrate—permits this to be removed from the transfer carrier 300. The transfer carrier 300 may thus be pulled away from the other layers. The transfer carrier 300 may therefore be considered not to form part of the security element 1.

The release layer 202 adjoins an embossment layer 4b with relief structure 4a and metal layer 14 beneath. The embossment layer 4b with relief structure 4a and metal layer 14 essentially forms the optically variable primary surface pattern 2. In the production, the relief structure 4a may be incorporated into the embossment layer 4b. Subsequently, the metal layer 14 may be applied and/or positioned for mirror reflection. The metal layer 14 has perforations in the form of the perforating elements 6. These perforations, after application of the metal layer 14, may be created in accordance with the different methods described herein. The at least two luminescent layers 7a, 7b may be applied to the perforated metal layer 14, directly or indirectly with an intermediate layer. In the embodiment of FIG. 2a, three illustrative luminescent layers 7a, 7b are present in regions, and may especially be fluorescent layers. In this case, a first luminescent layer 7a (luminescent layer 7a of the first type, indicated far left) having the first excitation wavelength and the first emission wavelength is not overlapped by the second luminescent layer 7b (luminescent layer 7b of the second type, indicated far right) having a second excitation wavelength and emission wavelength, and another first luminescent layer 7a indicated in the middle, or luminescent layer 7a of the first type, is overlapped by the second luminescent layer 7b having a second excitation and emission wavelength (on the right).

The two luminescent layers 7a, 7b may generally lie alongside one another essentially in a plane or be at least partly layered one on top of the other. In this way, the secondary surface pattern may firstly require multiple excitation wavelengths for complete discernibility, but also emit different wavelengths or colors, which appears particularly esthetically pleasing and effective and imparts high verification quality to the security element 1.

The luminescent layers 7a, 7b are covered by a primer layer and/or protective layer 203 in order to prevent these from becoming detached from the metal layer. An HSL layer as tie layer 204 (HSL: heatsealing lacquer) is disposed atop the primer layer and/or protective layer 203. The security element, i.e. in particular the layers 4b, 14, 7a, 7b and 203, may be secured on a target substrate with the aid of the tie layer 204. The metal layer 14 may be regarded as a layer opaque to the luminescence excitation light and emission light. However, the luminescent layers 7a, 7b, the HSL layer 204 and the primer layer and/or protective layer 203 are at least partially transparent to the luminescence excitation light and the emission light, such that an observer can see the effect achieved from this side, specifically the concealed secondary surface pattern 3 under excitation of luminescence. It may be the case that the concealed secondary surface pattern 3 is also discernible from the opposite side under excitation of luminescence, especially when the transfer carrier 300 has been pulled away. The release layer 202 may be transparent to the light emitted. It may after the transfer of the security element (detachment from the transfer carrier 300). The fact that a carrier layer may remain at least partially or completely on the substrate and/or may be transferred at least partially or completely to the target substrate as well is shown, for example, by FIG. 2b.

The position A₂ indicates an alternative or additional position, between release layer 202 and embossment layer 4b, especially embossment lacquer layer, on which there may be disposed the or one or more additional or alternative luminescent layers.

FIG. 2b is a schematic diagram of a layer arrangement 200b of a security element 1 as a strip transferable to the target substrate (L-LEAD) in one embodiment. The layer arrangement 200b differs primarily from that in FIG. 2a in that the carrier layer 201 is part of the security element 1. Optionally, an uppermost color reception layer 205 is additionally present.

The position B₂ indicates a further alternative or additional position, between color reception layer 205 and substrate 201, especially PET layer, on which there may be disposed the or one or more additional or alternative luminescent layers.

FIG. 3 is a schematic diagram of a security element 1 as a patch on a transfer carrier 300 in one embodiment. In particular, there is a multitude of patches (not shown) on the transfer carrier 300. The layer arrangement of the security element, by contrast with the layer arrangements 200a and 200b, has a plurality of HSL sublayers 204, four here. The HSL sublayers later collectively form a tie layer to the target substrate. Moreover, the layer arrangement has an optional carrier layer 211 and multiple optional protective layers or primer layers 213.

The transfer carrier 300, in this and in all other configurations, may have two carrier layers 301 that are bonded to one another via a tie layer 302. The transfer carrier 300 comprises the uppermost carrier layer 301, which serves as a support film, and a carrier layer 301 arranged immediately beneath, which is separated from the support film by a lamination adhesive layer as tie layer 302. As is well known, the layer structure of the security element on such a transfer carrier has particularly good divisibility/separability into regions (for example by stamping or lasering of the layer structure) without tearing the transfer carrier 300 as a result. The three uppermost layers 301 and 302 may be pulled off or removed from the security element 1.

In the layer arrangement of the security element, the luminescent layers 7a, 7b of the two different types (i.e. of the different excitation wavelengths) may be arranged alongside one another. The carrier layer 211 of the security element 203 and the lowermost HSL sublayer 204.

FIG. 4a is a schematic diagram of a layer arrangement 400a of a security element 1 as a patch transferable to a target substrate in one embodiment. The layer arrangement 400a has, in the following sequence: an uppermost PET layer 201, a varnish layer 401, a further PET layer 201, a further varnish layer 401, a further PET layer 201, a primer layer 203, an embossment varnish layer 4b, a perforated metal layer 14, the luminescent layers 7a, 7b of the two different types that are arranged one on top of another and alongside one another, a protective layer 203 and an HSL layer 204. Positions A₄ and B₄ indicate alternative or additional positions where the or further or alternative luminescent layers may be disposed, specifically A₄: between the release layer 202 and the further varnish layer 401, and B₄: between the uppermost primer layer 203 and the embossment varnish layer 4b.

FIG. 4b is a schematic diagram of a layer arrangement 400b of a security element 1 as a T-patch on a transfer carrier 300 in one embodiment. The layer arrangement 400b has, in the following sequence: an uppermost PET layer 301, a first release layer 402 and a second release layer 403, an embossment varnish layer 4b, a perforated metal layer 14, the luminescent layers 7a, 7b of the two different types that are arranged one on top of another and alongside one another, a primer layer 203 and an HSL layer 204. Position C₄ indicates an alternative or additional position where further or alternative luminescent layers may be disposed, specifically C₄: between the second release layer 403 and the embossment varnish layer 4b.

The described layer arrangements 200a, 200b, 400a, 400b are schematically endowed with the indicated UV-A-active luminescent layers (also UV-A layers). It is also possible for more UV-active and in particular UV-A-active layers, for example three, four, five, six or more, to be present in the layer arrangements. The UV layers may be present alongside one another or one on top of another. Use of such layer arrangements in filaments is also possible. However, this use is fairly limited because the filaments are regularly of small area. Filaments-preferably in a paper machine -are introduced into a paper substrate. All configurations are suitable in principle for introduction between sublayers of a target substrate. In such configurations, for example, it is possible to use a second tie layer disposed on the other side of the security element in order to achieve good adhesion of the security element in the target substrate.

The layers with identical reference numerals and/or designations in the described layer arrangements 200a, 200b, 400a, 400b or in the figures so far may have similar or identical properties, for example transparency or partial transparency; therefore, redundant information is not given specifically for each embodiment.

FIG. 5 is a schematic diagram of a method 100 of producing a security element 1 in one embodiment. The left-justified method steps 101, 102, 106 and 107 that are shown in FIG. 5 correspond essentially to the method 100 of the invention. The indented method steps 103, 104, 105 and 108 that are shown in FIG. 5 correspond to preferred method steps.

The method 100 of producing the security element 1 in one embodiment comprises: positioning 101 a metal layer 4 above a substrate and forming 102 a relief structure 4a in order to create an optically variable primary surface pattern 2; perforating and/or demetallizing 106 the metal layer 4 in the form of a multitude of perforating elements 6 in order to create a secondary surface pattern 3; and positioning 107 an at least partly transparent luminescent layer in the region of the secondary surface pattern 3.

In the method 100, the forming of the relief structure 4a may comprise the steps of: positioning 103 an embossment layer 4b onto the substrate; embossing 104 the relief structure 4a into the embossment layer 4b; and applying 105 the metal layer 4 to the embossment layer 4b. In the method 100, the perforating and/or demetallizing 106 of the metal layer 4 may further comprise at least one of the following method steps: a washing method, an etching method, a laser ablation, a metal pigment print with cutouts, a metal transfer method, a stamping operation, a mechanical and/or electrochemical removal operation, a pulling-away operation.

The security element produced may be applied to or introduced into a target substrate and may comprise a tie layer. It is possible here for adhesion islands to be formed 108 in the tie layer. For this purpose, the (UV) radiation-curable tie layer is irradiated through the perforating elements (with UV light). The result is cured adhesion islands in the tie layer. The adhesion islands locally provide better adhesion between security element and target substrate than in the uncured surrounding region of the tie layer. It is thus possible to prevent nondestructive detachment of the security element from the target substrate.

The method 100 may be executed in the sequence shown. However, the method 100 need not be executed in that sequence.

Some general remarks, examples and features are made/described hereinafter for (further) embodiments:

In general, the wavelengths of 365 nm and 254 nm are suitable for wavelength-dependent fluorescence in the detection of type 2 security features.

The reflector metal (e.g. aluminum) may be removed in small regions of the optically variable micro-relief (e.g. holograms, micromirrors, nanostructures, etc.) of the metal layer (reflector metal), in order to create perforating elements. This demetallization may be created by suitable methods, for example washing methods, etching methods, laser ablation, metal pigment printing with cutouts, metal transfer methods, etc. The perforating elements corresponding to demetallized regions may preferably be pattern dots and/or pattern elements having a diameter of 10-500 μm (preferably 50 -250 μm). The pattern elements may be not only dots, but also, for example, small alphanumeric characters, symbols, ornaments or lines. The pattern elements may be in a regular or chaotic arrangement. The totality of the pattern dots may constitute information or a motif. However, the dimensions of these demetallized pattern elements should not exceed a factor of 5 based on the resolution capacity of the human eye (100 μm).

In the case of use of high-resolution systems, a suitable demetallization method can be used to achieve the desired resolution. The pattern elements or cutouts (called the “negative text”) are barely perceptible in front view when observed in reflection, since the human eye perceives these regions as being outshone by the adjacent reflective regions. These regions of the film security element with the demetallized patterning are then highlighted with one or more luminescent and/or fluorescent colors (luminescent layer).

It is possible to provide the demetallized regions additionally with a semitransparent layer having transmittance of >25%. The luminescent and/or fluorescent colors may be excited at one or different wavelengths (e.g. at 365 nm, 395 nm, 254 nm UV broadband). The demetallization image, i.e. the substructure consisting of the perforating elements, can be seen by the naked eye only in transmission light and under UV light. In the region of the patterned demetallization, the luminescent and/or fluorescent area component is much smaller than in the outer regions, which may be fully demetallized. This leads partly to outshining of the patterned region by the fluorescence of the outer region, but this may be balanced out by skilful choice of color, for example lighter fluorescent colors on the inside and darker on the outside. Compensation is likewise possible by variation of pigmentation or reduction of layer thickness. The same compensation principles may apply when no semitransparent metallization remains.

### LIST OF REFERENCE SYMBOLS

1 security element
1a outline of a star
2 (optically variable) primary surface pattern
2a motif (star) with 3D effect, created by the optically variable primary surface pattern
3 (concealed) secondary surface pattern
4 opaque region
4a relief structure
4b embossment layer
5 perforation region
5a higher shape (e.g. cross) which is formed by the perforating elements or their substructure
6 a perforating element (that perforates the metal layer), or elements perforated into the metal layer
6a a first (perforating) element
6b a second (perforating) element
6c a third (perforating) element
7a first luminescent layer having a first excitation and/or emission wavelength
7b second luminescent layer having a second excitation and/or emission wavelength
8 opaque region
9 adhesion islands
14 metal layer
15 substructure
100 method of producing a security element
101 positioning a metal layer above a substrate
102 forming a relief structure in order to create an optically variable primary surface pattern
103 positioning an embossment layer onto the substrate
104 embossing the relief structure into the embossment layer
105 applying the metal layer to the embossment layer
106 perforating the metal layer in the form of a multitude of perforating elements in order to create a secondary surface pattern
107 positioning an at least partly transparent luminescent layer in the region of the secondary surface pattern
108 forming adhesion islands
200a layer arrangement of a security element as transfer strip
200b of a security element as lamination strip
201 carrier layer
202 release layer and/or adhesion layer
203 primer or protective layer
204 tie layer
205 color reception layer
211 carrier layer
213 protective layer
300 transfer carrier for security element
301 film layer, especially PET carrier and/or protective film
302 lamination adhesive
400a layer arrangement of a security element as lamination patch
400b layer arrangement of a security element as transfer patch
401 varnish layer
402 release layer 1
403 release layer 2
A position in layer arrangement for alternative or additional luminescent layer
B further position in layer arrangement for alternative or additional luminescent layer
C further position in layer arrangement for alternative or additional luminescent layer
da first distance: lateral distance between first and second perforating element
db second distance: lateral distance between second and third perforating element
r radius of a circular element

1.-15. (canceled)

16. A security element for a document of value, wherein the security element comprises:
an optically variable primary surface pattern comprising a metal layer having a relief structure; and
at least one concealed secondary surface pattern comprising a multitude of elements that perforate the metal layer, and at least one luminescent layer disposed at least partly in the region of the multitude of elements that perforate the metal layer.

17. The security element according to claim 16, wherein the luminescent layer comprises a fluorescent layer and/or a phosphorescent layer,
wherein the fluorescent layer is set up to fluoresce and the phosphorescent layer is set up to phosphoresce.

18. The security element according to claim 16, wherein the optically variable primary surface pattern comprises an embossment layer above and/or beneath which the metal layer is disposed.

19. The security element according to claim 16, further comprising a transparent region surrounding the primary surface pattern.

20. The security element according to claim 16, wherein the perforating elements have at least one of the following shapes: geometric shapes, especially triangular, rectangular, rhombus-like or circular shapes, including annular or solid circular shapes, alphanumeric symbols, symbols, ornaments, lines and meshes.

21. The security element according to claim 16, wherein the perforating elements have a length and/or width of 10-500 μm.

22. The security element according to claim 16, wherein the perforating elements have a lateral distance from one another of 10-500 μm.

23. The security element according to claim 16, wherein the luminescent layer is excitable in the UV range at discrete wavelengths or in a continuous spectral range, especially between 315 and 405 nm.

24. The security element according to claim 16, wherein there is disposed at least one semitransparent layer having a transparency of at least 25% at least in the region of the secondary surface pattern.

25. The security element according to claim 16, wherein the security element also comprises a radiation-activatable tie layer,
wherein an adhesion island in the tie layer is creatable by irradiating the tie layer through the element perforating the metal layer.

26. A method of producing a security element, comprising:
positioning a metal layer above a substrate and forming a relief structure in order to create an optically variable primary surface pattern;
perforating the metal layer in the form of a multitude of perforating elements in order to create a secondary surface pattern; and
positioning an at least partly transparent luminescent layer in the region of the multitude of perforating elements.

27. The method according to claim 26, wherein the forming of the relief structure comprises:
positioning an embossment layer onto the substrate;
embossing the relief structure into the embossment layer; and
applying the metal layer to the embossment layer.

28. The method according to claim 26, wherein the perforating of the metal layer comprises at least one of the following methods: a washing method, an etching method, a laser ablation, a metal pigment print with cutouts, a metal transfer method, a stamping operation, a mechanical and/or electrochemical removal operation, a pulling-away operation.

29. The method according to claim 26, wherein adhesion islands are formed on application or introduction of the security element produced onto a target substrate, especially in that the adhesion islands are generated by irradiation of a radiation-curable tie layer through the perforating elements.

30. The method as claimed in claim 29, wherein the tie layer comprises a UV-curing polymer and/or the adhesion islands of the tie layer provide locally better adhesion to the target substrate as detachment safeguard for the security element.
